(19) United States
(12) Patent Application Publication
(10) Pub. No.: US 2024/0320020 A1
(43) Pub. Date: Sep. 26, 2024

(54) Apparatuses, Devices, Methods and Computer Programs for Providing and Executing Code Written in a Dynamic Script Language

(71) Applicant: Intel Corporation, Santa Clara, CA (US)

(72) Inventors: Junyong DING, Shanghai (CN); Qi ZHANG, Shanghai (CN); Shiyu ZHANG, Shanghai (CN); Yuan CHEN, Shanghai (CN); Hao XU, Shanghai (CN); Tao PAN, Shanghai (CN)

(21) Appl. No.: 18/570,677

(22) PCT Filed: Dec. 14, 2021
(86) PCT No.: PCT/CN2021/137807

§ 371 Date: Dec. 15, 2023

(51) Int. Cl. G06F 9/455

(52) U.S. Cl. CPC G06F 9/45516; G06F 9/45529

(57) ABSTRACT

Various examples relate to an apparatus, a device, a method, and a computer program for executing code written in a dynamic script language and to an apparatus, a device, a method, and a computer program for providing code of a dynamic scripting language. The apparatus for executing code written in a dynamic script language comprises processing circuitry con-figured to obtain code written in the dynamic script language, obtain one or more profiles for accelerating an execution of the code, with the one or more profiles being bundled with the code, and execute the code based on the one or more profiles.

### BACKGROUND

Dynamic script languages are widely used in the industry. For example, JavaScript is extremely popular and heavily used on the client side (e.g., in web browsers or hybrid web applications) as well as on the edge/server side (e.g., through frameworks such as Node.js). Dynamic script languages are often easy to learn and use, and usually yield a high productivity.

Traditional programming languages such as C/C++, Java/.NET etc. are usually strongly typed. Applications written in these languages are usually compiled into binaries once (or twice if using profile-guided optimization). The binaries are then shipped to end users and executed.

By contrast, applications written in dynamic script languages are shipped with source code (e.g., JavaScript files). Every time they execute, they have to be interpreted or compiled on the fly, e.g., using Just-In-Time compilation. This is majorly because that the script engine (sometimes also referred as runtime) are required to handle many so-called “dynamics” caused by the nature of the dynamic script language. Such dynamics include but not limited to the type of variables, the signature of functions, etc., which are essential for compilation of high-performance binaries. They are well defined in traditional languages but are missing in dynamic script languages. Such dynamics may also include information that guides the optimization being performed by the compiler. For example, information about how often a function is executed is considered an important heuristic to decide on whether this function should be in-lined or not. Whether a branch is more likely to take may result in better code layout of the clauses of an “if” statement. Such dynamics are not exclusive to dynamic script languages but are also widely used in PGO (Profile Guided Optimization) for traditional programming languages to improve the binaries to be shipped out.

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus or device for executing code written in a dynamic script language, and of a computer system comprising the apparatus or device;

FIG. 1b shows a block diagram of an example of a system comprising two computer systems;

FIG. 1c shows a flow chart of an example of a method for executing code written in a dynamic script language;

FIG. 2a shows a block diagram of an example of an apparatus or device for providing code of a dynamic scripting language, and of a computer system comprising the apparatus or device;

FIG. 2b shows a flow chart of an example of a method for providing code of a dynamic scripting language;

FIG. 3 shows a schematic diagram of an example of a script engine for executing JavaScript code;

FIG. 4 shows a schematic diagram of an example illustrating drawbacks of profiling in a script engine;

FIG. 5 shows a schematic diagram of an example of an overall flow of profiles at a developer and an end user;

FIG. 6 shows a schematic diagram of an example illustrating how drawbacks can be overcome with respect to profiling in a script engine;

FIG. 7 shows a flow diagram of an example of a flow for loading separated profiles from a script;

FIG. 8 shows a schematic diagram of an example of a flow for deciding on whether or not to use information from a profile during compilation;

FIG. 9 shows a schematic diagram of an example of a representation of a profile;

FIG. 10 shows a table of an example of a database of compilation units, states, and profile; and

FIG. 11 shows a state diagram of an example of state transitions of a compilation unit.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

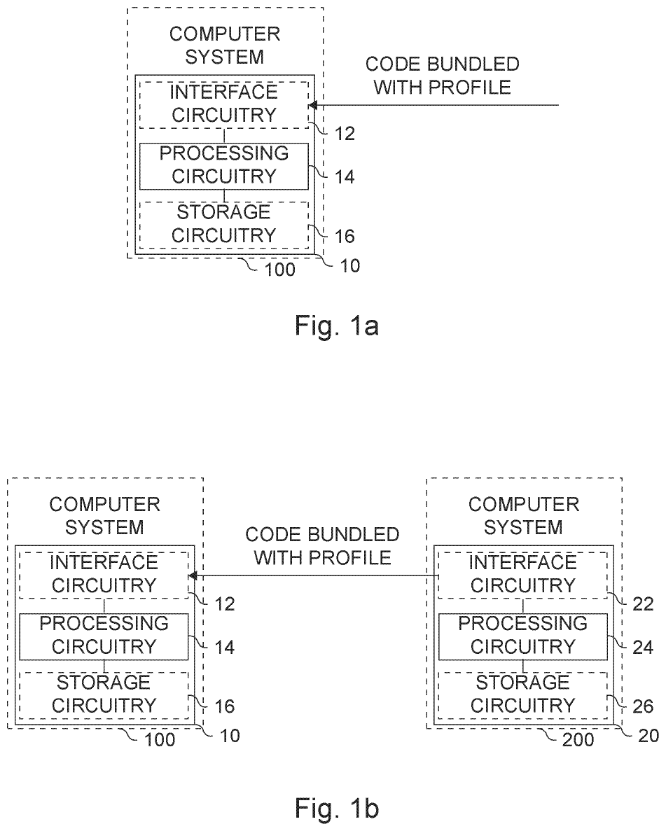

FIG. 1a shows a block diagram of an example of an apparatus 10 or device 10 for executing code written in a dynamic script language, and of a computer system 100 comprising the apparatus 10 or device 10. The apparatus 10 comprises circuitry that is configured to provide the functionality of the apparatus 10. For example, the apparatus 10 of FIG. 1a comprises (optional) interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the apparatus, in conjunction with the interface circuitry 12 (for exchanging information, e.g., with the computer system 200 and/or the apparatus 20 introduced in connection with FIGS. 1b and/or 2a) and the storage circuitry (for storing information) 16. Likewise, the device 10 may comprise means that is/are configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processing circuitry 14, (optional) means for communicating 12, which may correspond to or be implemented by the interface circuitry 12, and (optional) means for storing information 16, which may correspond to or be implemented by the storage circuitry 16.

The processing circuitry or means for processing 14 is configured to obtain code written in the dynamic script language. The processing circuitry or means for processing 14 is configured to obtain one or more profiles for accelerating an execution of the code. The one or more profiles are bundled with the code. The processing circuitry or means for processing 14 is configured to execute the code based on the one or more profiles.

The apparatus 10 operates based on the code that is written in the dynamic script language. To obtain the code, the code may be obtained (e.g., received) from a further computer system, such as a server computer. For example, the code may be received from a further computer system 200, e.g., via a server used for storing the code and the one or more profiles. FIG. 1b shows a block diagram of an example of a system comprising the computer system 100 (with the apparatus or device 10) and another computer system 200 (with an apparatus or device 20), which may be a server computer system. FIG. 1b further shows a system comprising the apparatus 10 for executing code written in a dynamic script language and the apparatus 20 for providing the code of the dynamic scripting language.

FIG. 1c shows a flow chart of an example of a corresponding (computer-implemented) method for executing code written in a dynamic script language. The method comprises obtaining 110 the code written in the dynamic script language. The method comprises obtaining 120 the one or more profiles for accelerating an execution of the code. The one or more profiles are bundled with the code. The method comprises executing 160 the code based on the one or more profiles.

In the following, the functionality of the apparatus 10, the device 10, the method and of a corresponding computer program is introduced in connection with the apparatus 10. Features introduced in connection with the apparatus 10 may be likewise included in the corresponding device 10, method and computer program.

Various examples of the present disclosure relate to an apparatus, device, method, and computer program for executing code written in a dynamic script language. In particular, the above components may implement an improved concept for a script engine for executing code written in a dynamic script language. In other words, the apparatus or device may implement a script engine, and the method and computer program may provide the functionality of the script engine.

The present disclosure relates to dynamic script languages. In this context, the term “dynamic script language” is used to denote a script language that is generally dynamically interpreted (however, Just In Time (JIT) compilation of portions of the script are possible), and that comprises dynamic elements that are determined at runtime. In other words, the dynamic script language may be a programming language, which executes one or more tasks at runtime that static programming languages perform during compilation. For example, the code written in the dynamic script language may be obtained as source code (e.g., plain source code or obfuscated/minimized source code), i.e., not as compiled code. Dynamic script languages may operate without strong variable types, for example, such that the type of a variable can change during execution. Moreover, in some examples, objects and definitions may be changed during runtime. For example, the dynamic script language may be a script language such as JavaScript or Python. In particular, the dynamic script language may be a script language to be executed by a script engine of a web browser or web-based framework.

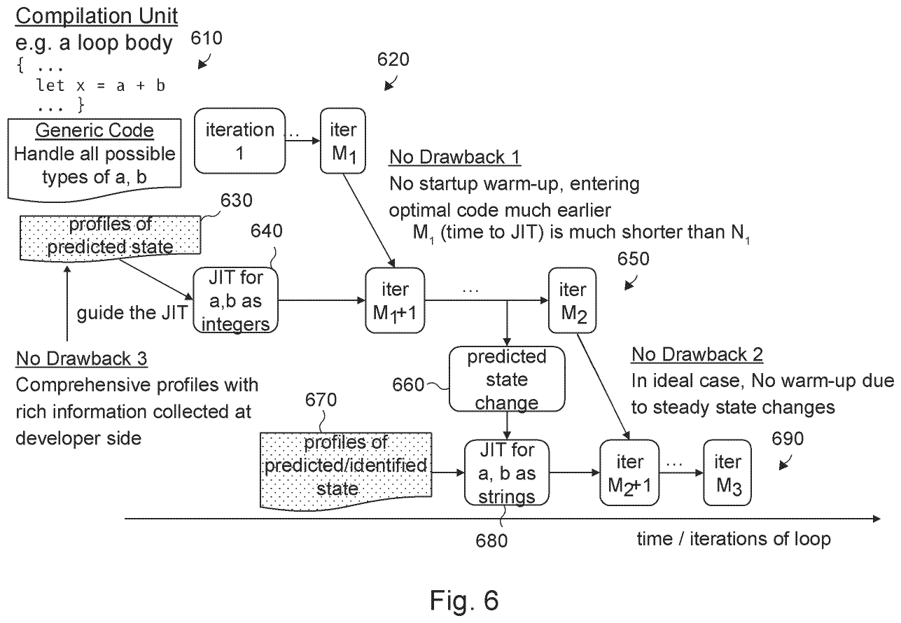

The process starts with obtaining the code and the one or more profiles, which are bundled with the code. Generally, both the code and the one or more profiles may be obtained, e.g., received from a server computer, such as the computer system 200 shown in FIG. 1b. For example, the processing circuitry may be configured to request both the code and the one or more profiles from the server. In some examples, the code may comprise a reference to the one or more profiles, e.g., a uniform resource locator (URL) to the one or more profiles. Alternatively, the one or more profiles may be requested based from the server by deriving the URL of the one or more profiles from the file name, and thus URL, of the code. For example, the processing circuitry may be configured to request the code from a server as a file having a filename, and to request the one or more profiles from the server as a file having a filename that is derived from the filename of the code. Accordingly, as further shown in FIG. 1c, the method may comprise requesting 115 the code from a server as a file having a filename and requesting 125 the one or more profiles from the server as a file having a filename that is derived from the filename of the code. For example, as will be illustrated in connection with FIG. 7, if the code has a filename of <filename>.<extension>, the one or more profiles may have the filename of <filename>.<profiles> or <filename>.<profile[0 . . . n]>. Accordingly, in some cases, each profile may be contained in a separate file, while, in some other cases, the one or more profiles may be contained in a single file. For example, the file containing the code may be separate from the file or files containing the one or more profiles. This way, backwards compatibility may be retained, as script engines that do not support this feature can ignore the one or more profiles completely.

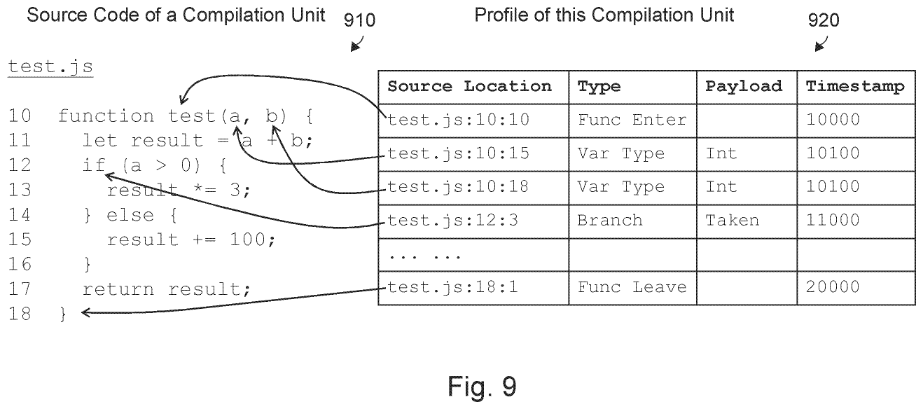

Moreover, in various examples, the proposed concept may be implemented to be agnostic of the script engine being used to interpret the code (as long as the script engine supports the features). In particular, the one or more profiles may be defined according to a script execution engine-agnostic format. For example, the one or more profiles may be defined without reference to internal representations of a JIT compiler of the respective script engine and/or without reference to a debug symbol. Instead, the one or more profiles may be defined with reference to the code. Each entry of the one or more profiles may reference a position in the code, e.g., by filename, line number and character number, as shown in connection with FIG. 9. This way, different script engines may use the same one or more profiles, i.e., the one or more profiles are in a script engine agnostic-format.

In general, each profile may relate to a so-called compilation unit, which is the granularity level of the JIT compiler being employed during execution of the code. For example, a compilation unit may be a function defined in the code or a loop body of a loop contained within the code.

In the present disclosure, the term “profile” was chosen, as some aspects of the present disclosure are similar to the technique called “profile guided optimization” (POG) being used for optimization during compilation of static programming languages. In this context, a profile comprises information on dynamic aspects of the code, such as variable types, information on a likelihood of branches being taken, information on a number of invocations of a function. The one or more profiles may thus comprise profiling data with respect to dynamic aspects, such as variable types, or metrics with respect to loops or branches, of the code.

The present disclosure relates to dynamic script languages. One characteristic of dynamic script languages is, that they are dynamic, i.e., the code, or the behavior during execution, may change over time. However, in order to speed up execution of the code, portions (e.g., compilation units) of the code may be compiled using a JIT compiler, which necessitates some static behavior of the code. In other words, the code written in the dynamic script language may be considered to be intermittently static (i.e., “steady”) during execution of the code. JIT compilation can then be applied on this so-called “steady state” of the execution of the code, i.e., a state, during which the dynamics do not change or where changes are limited. In other words, dynamic aspects of the code are quasi-static (i.e., intermittently static) during a steady state of the execution of the code. Since the one or more profiles comprise information on the dynamics, the one or more profiles may be specific to the respective steady states. In other words, each profile may be associated with a steady state of the execution of the code. The processing circuitry may thus be configured to obtain a plurality of profiles that are bundled with the code, with each profile being associated with a steady state of the execution of the code. In other words, for each steady state, a separate profile may be used.

As is evident from the possible existence of multiple steady states per execution, in some cases, the execution may transition from one steady state to another steady state. For example, the execution of the code may transition from a steady state to another steady state if a dynamic aspect of the code changes during execution of the code. For example, the execution of the code may transition if a variable type changes, or if a likelihood of a branch being taken changes etc. For example, the execution of the code may transition from a steady state to another steady state if at least one of a type of a variable (used in a code), a metric on a likelihood of one or more branches being taken (e.g., depending on an evaluation being performed with respect to an “if” statement), a metric on an approximate number of invocations of a function/compilation unit (i.e., an approximate metric indicating how often the function or compilation unit is being executed), a metric on a cache miss ratio (i.e., a ratio between how often the data being requested is in cache and how often it is not) and a metric on a number of functions being executed changes during execution of the code.

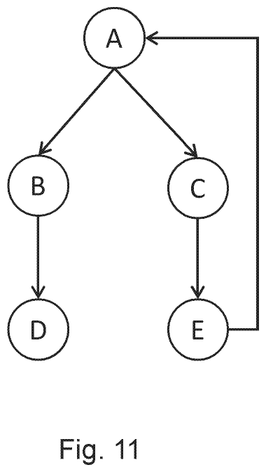

To predict the transition between two steady states, information on the triggers of such transitions may be included with the one or more profiles. For example, the processing circuitry may be configured to obtain information on one or more transitions between the steady states of the execution of the code that is bundled with the code (e.g., contained in the one or more profiles), and to select a profile of the plurality of profiles based on the information on the one or more transitions between the steady states of the execution. Accordingly, the method may comprise obtaining 130 the information on the one or more transitions between the steady states of the execution of the code that is bundled with the code and selecting 140 a profile of the plurality of profiles based on the information on the one or more transitions between the steady states of the execution. For example, the information on the one or more transitions between the steady states of the execution of the code may comprise, for each steady state, information on at least one of a preceding steady state and a subsequent steady state, i.e., information on which steady state is likely to transition to the given state, and to which steady state the given state is likely to transition. Moreover, the information on the one or more transitions between the steady states of the execution may comprise information on a trigger or timing of the transition, i.e., one or more dynamics (such as variable types, branches being taken) that indicate that the transition to the other steady state occurs, or a timestamp at which the transition is likely to occur. The processing circuitry may be configured to generate a state diagram based on the information on the one or more transitions between the steady states of the execution, e.g., based on the information on the preceding/subsequent states. An example is shown in FIG. 11.

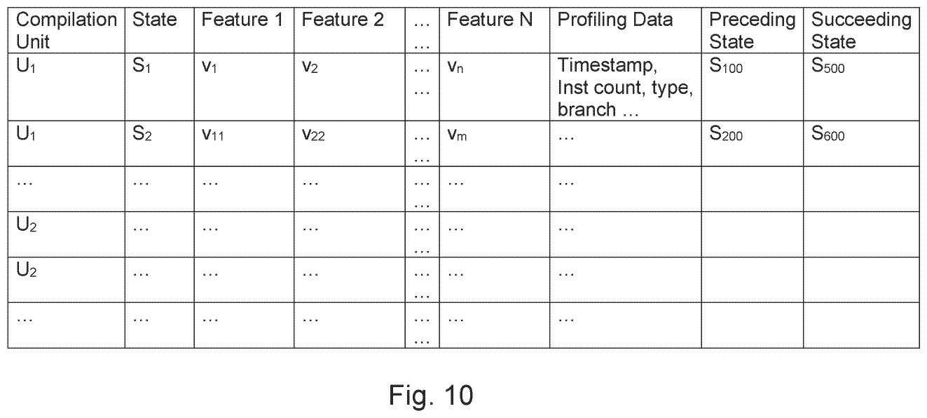

To determine the steady state the execution is currently in, the state diagram may be used. For example, as shown in FIG. 11, the initial steady state of the execution may be determined based on the state diagram. Alternatively, or additionally, the one or more profiles and/or the information on the one or more transitions between the steady states may comprise information that is used to determine the steady state the execution is currently in. For example, the information on the one or more transitions between the steady states of the execution, or the one or more profiles, may comprise information on one or more features with respect to the “dynamics” that characterize the respective steady state. This concept is further illustrated in connection with FIG. 10, where an n-dimensional vector is used to define the state, with the vector being based on the features. For example, one or more of the following features may be used: a) current type of variable X in the application, b) whether the function F has been executed more than 1000 times, c) whether the function F has been improved or optimized for this state before, d) whether the recent branch taken ratio of an “if” statement is greater than 0.7, e) whether the recent cache miss ratio of this unit is greater than 0.01, of f) whether a total number of executed functions (not only this one) is greater than 10000. The processing circuitry may be configured to determine the values of the features with respect to the current state of the execution, and to identify a steady state of the plurality steady states based on a correspondence or similarity between the values of the features with respect to the current state of the execution and the features defined for the respective states. Depending on the identified steady state, the corresponding profile may be selected.

In addition to the one or more profiles that are bundled with the code, the script engine, i.e., the apparatus, device, method, and computer program, may perform profiling as well. The profiles that are determined using local profiling may be combined with the profiles that are bundled with the code. For example, the processing circuitry may be configured to perform profiling during execution of the code to determine one or more further (i.e., local) profiles, to merge the one or more profiles with the one or more further (local) profiles, and to execute the codes based on the merged profiles. Accordingly, the method may comprise performing 150 profiling during execution of the code to determine one or more further profiles, merging 155 the one or more profiles with the one or more further profiles, and executing 160 the codes based on the merged profiles. For example, the determining of the one or more further profiles may be performed as usual in script engines.

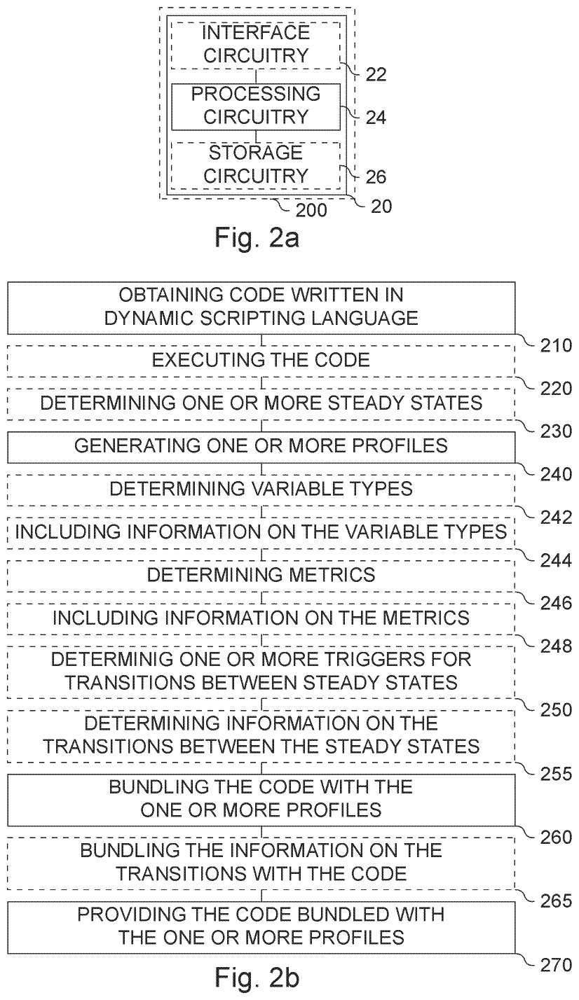

Based on the one or more profiles (and/or the merged profiles), the code is executed. The one or more profiles (e.g., the merged profiles) are used to accelerate the execution of the code. In connection with FIGS. 3 to 11, the term “optimization” is used. In this context, the term “optimization” does not imply, that the result of the optimization is necessarily the optimal result. The term “optimization” or “optimized” merely indicates, that an improvement is made vis-à-vis a version where no optimization has taken place.

Using the one or more profiles, various techniques may be used to accelerate (i.e., “optimize”) the execution of the code. For example, depending on the one or more profiles, a portion of the code may be inlined, i.e., the instructions of a first function are included (i.e., “inlined”) in a second function calling the first function, so that the first function need not be called from the second function. For example, the processing circuitry may be configured to inline a portion of the code of a first function in a second function based on the one or more profiles, e.g., if the one or more profiles indicates that the first function is often called (in a loop, for example). Another technique relates to JIT compilation. For example, the processing circuitry may be configured to perform JIT compilation during execution of the code, with the JIT compilation being based on the one or more profiles. For example, the processing circuitry may be configured to perform the JIT compilation based on the code and based on the profiling data with respect to dynamic aspects of the code.

For example, the one or more profiles may comprise information on variable types of variables being used in the code. The processing circuitry may be configured to execute the code with the variable types specified by the information on the variable types. In particular, the processing circuitry may be configured to perform JIT compilation of the code with the variable types specified by the information on the variable types. Additionally, or alternatively, the one or more profiles may comprise metrics on one or more of a likelihood of one or more branches being taken, an approximate number of invocations of a function, a cache miss ratio, and a number of functions being executed. The processing circuitry may be configured to adjust the execution of the code based on the metrics. Accordingly, the method may comprise adjusting 165 the execution of the code based on the metrics. For example, the processing circuitry may be configured to perform inlining or JIT compilation based on the metrics. For example, the processing circuitry may be configured to inline a function if the approximate number of invocations exceeds a threshold, to the processing circuitry may be configured to perform JIT compilation of a function (or of a loop body) if the approximate number of invocations of the function or loop body exceeds a threshold. For example, the processing circuitry may be configured to limit the JIT compilation to one out of two branches based on the likelihood of the two branches being taken.

In various examples, the JIT compilation is based on the steady state the execution is currently in. For example, the processing circuitry may be configured to perform JIT compilation based on the profile or profiles being associated with the steady state the execution is currently in.

Moreover, the processing circuitry may be configured to (proactively, i.e., before the steady state transitions) perform JIT compilation for a steady state that is likely to follow the steady state the execution currently is in, and to switch to the compiled version of the code for the subsequent steady state once the steady state transitions.

More details on the proposed concept with respect to the script engine is discussed with respect to FIGS. 3 to 11.

The interface circuitry 12 or means for communicating 12 of FIG. 1a may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 of FIG. 1a may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 of FIG. 1a may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

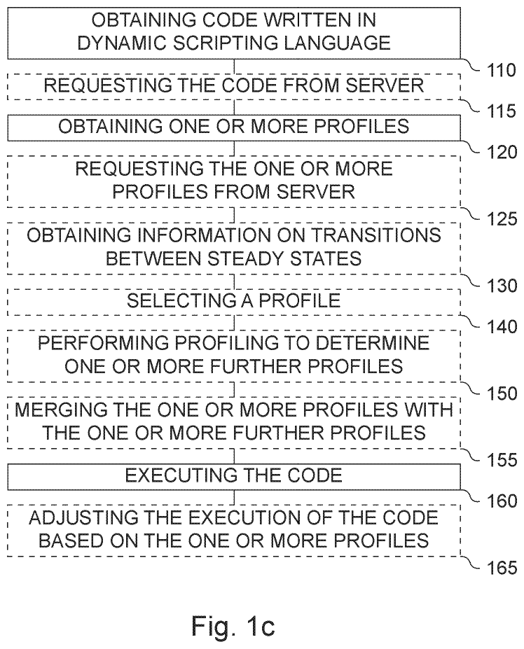

More details and aspects of the apparatus 10, device 10, method, computer program and computer system 100 are mentioned in connection with the proposed concept or one or more examples described above or below (e.g., FIGS. 2a to 11). The apparatus 10, device 10, method, computer program and computer system 100 may comprise one or more additional optional features corresponding to one or more aspects of the proposed concept, or one or more examples described above or below.

FIG. 2a shows a block diagram of an example of an apparatus 20 or device 20 for providing code of a dynamic scripting language, and of a computer system 200 comprising the apparatus or device 20. The apparatus 20 comprises circuitry that is configured to provide the functionality of the apparatus 20. For example, the apparatus 20 of FIG. 2b comprises (optional) interface circuitry 22, processing circuitry 24 and (optional) storage circuitry 26. For example, the processing circuitry 24 may be coupled with the interface circuitry 22 and with the storage circuitry 26. For example, the processing circuitry 24 may be configured to provide the functionality of the apparatus, in conjunction with the interface circuitry 22 (for exchanging information, e.g., with the computer system 100 and/or the apparatus 10 introduced in connection with FIGS. 1a to 1c) and the storage circuitry (for storing information) 26. Likewise, the device 20 may comprise means that is/are configured to provide the functionality of the device 20. The components of the device 20 are defined as component means, which may correspond to, or implemented by, the respective structural components of the apparatus 20. For example, the device 20 of FIG. 2b comprises means for processing 24, which may correspond to or be implemented by the processing circuitry 24, (optional) means for communicating 22, which may correspond to or be implemented by the interface circuitry 22, and (optional) means for storing information 26, which may correspond to or be implemented by the storage circuitry 26.

The processing circuitry or means for processing 24 is configured to obtain the code written in the dynamic scripting language (e.g., by reading the code from storage, or by the code being passed by an integrated development environment). The processing circuitry or means for processing 24 is configured to generate one or more profiles for accelerating an execution of the code. The processing circuitry or means for processing 24 is configured to bundle the code with the one or more profiles. The processing circuitry or means for processing 24 is configured to provide the code bundled with the one or more profiles.

FIG. 2b shows a flow chart of an example of a corresponding (computer-implemented) method for providing code of a dynamic scripting language. The method comprises obtaining 210 the code written in the dynamic scripting language. The method comprises generating 240 one or more profiles for accelerating an execution of the code. The method comprises bundling 260 the code with the one or more profiles. The method comprises providing 270 the code bundled with the one or more profiles.

In the following, the functionality of the apparatus 20, of the device 20, of the method and of a corresponding computer program are introduced in connection with the apparatus 20. Features introduced in connection with the apparatus 20 may likewise be applied to the corresponding device 20, method and computer program.

While the apparatus, device, method, and computer program of FIGS. 1a to 1c relate to an execution of code written in a dynamic scripting language, the apparatus, device, method, and computer program relate to a generation and provision of the one or more profiles that are bundled with the code. In particular, the apparatus, device, method, and computer program are used to generate the one or more profiles that are to be used in conjunction with the code. Therefore, the process starts with the code, which is, in general, not altered by the proposed concept. The processing circuitry is thus configured to obtain the code written in the dynamic scripting language, e.g., by reading the code form memory or storage, or by the code being passed as argument to the apparatus, device, method, or computer program.

The processing circuitry is configured to generate the one or more profiles for accelerating the execution of the code. In other words, the processing circuitry is configured to perform profiling on the code. However, compared to profiling being conducted by the script engine of a web browser, the profiling conducted in this context may be more comprehensive. For example, the profiling being conducted may be similar to the profiling being conducted in profile guided optimization, e.g., to determine metrics of the execution. For example, the processing circuitry may be configured to determine metrics on one or more of a likelihood of one or more branches being taken, an approximate number of invocations of a function, a cache miss ratio, and a number of functions being executed, and to include the metrics in the one or more profiles. Accordingly, as further shown in FIG. 2b, the method may comprise determining 246 metrics on one or more of a likelihood of one or more branches being taken, an approximate number of invocations of a function, a cache miss ratio, and a number of functions being executed, and including 248 the metrics in the one or more profiles. Another aspect that is usually not necessary in profile-guided optimization relates to the typing of the variables, as PGO is usually applied on statically typed programming languages. However, in the present context, the types of the variables are of particular interest. Therefore, the processing circuitry may be configured to determine variable types of variables being used, and to include information on the variable types of the variables being used in the code in the one or more profiles. Accordingly, as further shown in FIG. 2b, the method may comprise determining 242 variable types of variables being used and including 244 information on the variable types of the variables being used in the code in the one or more profiles. In more general terms, the processing circuitry may be configured to determine profiling data with respect to dynamic aspects of the code, and to include the profiling data in the one or more profiles. As already outlined in connection with FIGS. 1a to 1c, the processing circuitry may be configured to generate the one or more profiles according to a script execution engine-agnostic format, e.g., by defining the one or more profiles may be with reference to the code (without reference to internal representations of a JIT compiler and/or without reference to debug symbols).

In general, the one or more profiles may be generated using various means. For example, while JavaScript is a dynamically typed scripting language, extensions such as Microscope TypeScript can be used to introduce a form of static typing (for debugging purposes) to the code (albeit only within the integrated development environment). The processing circuitry may be configured to generate the one or more profiles based on the TypeScript annotations, e.g., to determine the variable types.

Many dynamic aspects, however, may be gathered by executing the code, e.g., by manually using the code via a script engine, and monitoring the execution of the code. Accordingly, the processing circuitry may be configured to generate the one or more profiles by executing the code. In other words, the method may comprise generating 240 the one or more profiles by executing 220 the code. The processing circuitry may be configured to monitor the execution of the code, e.g., to perform profiling during the execution of the code, to determine the one or more profiles. Accordingly, the method may comprise monitoring the execution of the code.

As outlined in connection with FIGS. 1a to 1c, the dynamic nature of dynamic script languages may load to scenarios, where the dynamic aspects of the code change during execution. In general, during execution of the code, these dynamic aspects are intermittently static, so that the execution of the code tends to transition from one steady state (with the dynamics having one set of values) to another steady state (with the dynamics having another set of values) when the dynamic aspects change during the execution, e.g., when the variable type of a variable changes, or when the likelihood of a branch being taken changes. The processing circuitry may be configured to determine one or more steady states during the execution of the code, and to generate the one or more profiles based on the one or more steady states, so that each profile is associated with a steady state of the execution of the code. Accordingly, the method may comprise determining 230 the one or more steady states during the execution of the code and generating 240 the one or more profiles based on the one or more steady states, so that each profile is associated with a steady state of the execution of the code. For example, the execution of the code may transition from a steady state to another steady state if a dynamic aspect of the code changes during execution of the code. For example, the one or more profiles may be changed by monitoring the dynamic aspects, e.g., the variable types, branch taken ratios, number of invocations of a function etc., and determining separate steady states when a dynamic aspect (or a pre-defined number of dynamic aspects) change and then remain the same for some time (such that they are steady again. For example, the execution of the code may transition from a steady state to another steady state if at least one of a type of a variable (used in a code), a metric on a likelihood of one or more branches being taken (e.g., depending on an evaluation being performed with respect to an “if” statement), a metric on an approximate number of invocations of a function/compilation unit (i.e., an approximate metric indicating how often the function or compilation unit is being executed), a metric on a cache miss ratio (i.e., a ratio between how often the data being requested is in cache and how often it is not) and a metric on a number of functions being executed changes during execution of the code. For different steady states, different profiles may be generated. In other words, the processing circuitry may be configured to, if the processing circuitry determines a plurality of steady states, generate a plurality of profiles, with each profile being associated with a steady state of an execution of the code. Accordingly, the method may comprise, if the means for processing determines a plurality of steady states, generating 240 a plurality of profiles, with each profile being associated with a steady state of an execution of the code.

As a consequence of identifying the different steady states, not only the existence of the different steady states may be determined, but also the dynamic features underlying the steady states, and, if possible, the triggers that can be used to determine or predict the transition between two steady states. For example, the processing circuitry may be configured to determine one or more triggers for one or more transitions between the plurality of steady states, to determine information on the one or more transitions between the steady states based on the one or more triggers, and to bundle the information on the one or more transitions with the code. Accordingly, as further shown in FIG. 2b, the method may comprise determining 250 the one or more triggers for the one or more transitions between the plurality of steady states, determining 255 the information on the one or more transitions between the steady states based on the one or more triggers, and bundling 265 the information on the one or more transitions with the code. For example, the processing circuitry may be configured to determine, for the information on the one or more transitions between the steady states of the execution of the code, for each steady state, information on at least one of a preceding steady state and a subsequent steady state, i.e., information on which steady state is likely to transition to the given state, and to which steady state the given state is likely to transition. Moreover, the processing circuitry may be configured to determine, for the information on the one or more transitions between the steady states of the execution, information on a trigger or timing of the transition, i.e., one or more dynamics (such as variable types, branches being taken) that indicate that the transition to the other steady state occurs, or a timestamp at which the transition is likely to occur. The processing circuitry may be configured to include such information in the information on the one or more transitions between the steady states of the execution.

In general, each steady state is based on the values taken by the dynamic aspects outlined in connection with FIGS. 1a to 1c. The processing circuitry may be configured to include, in the information on the one or more transitions between the steady states of the execution, or in the one or more profiles, information on one or more features with respect to the “dynamics” that characterize the respective steady state. This concept is further illustrated in connection with FIG. 10, where an n-dimensional vector is used to define the state, with the vector being based on the features. The processing circuitry may be configured to determine the values of the features with respect to the current state of the execution, and to include information on the values of the features in the information on the one or more transitions between the steady states of the execution or in the one or more profiles. In some examples, the processing circuitry may be configured to determine an embedding of the features, e.g., using a machine-learning model being trained to determine an embedding of the features.

Once the one or more profiles are generated, they are bundled with the code, and provided together with the code, e.g., to the computer system 100. For example, the one or more profiles may be provided as a file (containing one or more profiles) or as multiple files (with each file comprising a profile. For example, the one or more profiles may be provided using a predefined format, such as the JavaScript Object Notation (JSON). For example, the processing circuitry may be configured to provide the code as a file having a filename, and to provide the one or more profiles as a file having a filename that is derived from the filename of the code (thus bundling the code with the one or more profiles). Accordingly, the method may comprise providing 270 the code as a file having a filename and providing 270 the one or more profiles as a file having a filename that is derived from the filename of the code. For example, the processing circuitry may be configured to derive the filename of the file of the one or more profiles from the filename of the file of the code. Alternatively, the processing circuitry may be configured to insert a URL of the one or more profiles in the code to bundle the one or more profiles with the code. For example, the code and the bundled one or more profiles may be provided to, or via, a (web) server being used to host the code together with the one or more profiles.

The interface circuitry 22 or means for communicating 22 of FIG. 2b may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processing circuitry 24 or means for processing 24 of FIG. 2b may be implemented using one or more processing units, one or more processing devices, any means for processing, such as a processor, a computer or a programmable hardware component being operable with accordingly adapted software. In other words, the described function of the processing circuitry 24 or means for processing may as well be implemented in software, which is then executed on one or more programmable hardware components. Such hardware components may comprise a general-purpose processor, a Digital Signal Processor (DSP), a micro-controller, etc.

For example, the storage circuitry 26 or means for storing information 26 of FIG. 2b may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 20, device 20, method, computer program and computer system 200 are mentioned in connection with the proposed concept or one or more examples described above or below (e.g., FIG. 1a to 1c, 3 to 11). The apparatus 20, device 20, method, computer program or computer system 200 may comprise one or more additional optional features corresponding to one or more aspects of the proposed concept, or one or more examples described above or below.

Various examples of the present disclosure relate to a concept for redistributable state-based profiles to guide just-in-time compilation of dynamic script languages.

For traditional (i.e., non-dynamic) programming languages, the dynamics are either pre-defined (e.g., as the types or signatures are statically assigned), or collected and applied only once to generate the binary to ship for many executions (e.g., in traditional PGO). In dynamic script languages however, such dynamics are generally figured out by the script engine during every execution by observing the dynamic behavior of the code during execution. Moreover, such dynamics can change significantly, not only from one execution to another, but also from one period to another even during the same execution.

In the following, such dynamics collected by the script engine are denoted “profiles”. In the following, an example is given on how the type information inside the profile is collected and utilized by a script engine, using a JavaScript example. The example is given using the JavaScript code snippet “let x=a+b” where x, a and b are all variables. Since the types of a and b aren't declared and can be changed from time to time, every time this instruction is encountered, the script engine is generally required to check their current real types at this moment, and switch to the correct logic. For example, at one time, a and b are integers and the correct logic is integer addition, while at another time, a and b are strings and string concatenation is to be performed. This approach is very inefficient, as it takes effort to enumerate and check all possible combinations of types. Some script engines have evolved to accelerate it by using a technique called type speculation and specialization in JIT (Just-In-Time compilation). In the technique, the JIT internally observes the type of a and b from the start of this execution and may conclude some useful facts. For example, for a long enough period, the type of a and b may be stable, with the types being integers. Later on, based on such observation, the JIT can create specialized and thus more efficient code by assuming that a and b will still be integers in the future. For example, a+b may be compiled into a register add instruction here. Of course, some checks are added around this block of JITted code to guard such speculation and fallback to a slow path if a and b are not integers in future execution.

As mentioned above, type information is just part of the profile that is collected during the execution. A lot of information, such as types, only makes sense when the respective information is stable. For example, the profiled type information might not help much if the type of a and b are totally randomized. When certain dynamics become stable, e.g., the type does not change or changes in a regular pattern, the execution reaches a so-called steady state.

Furthermore, the JIT engine usually does not compile the entire application as a whole. Instead, the JIT may compile a small portion when necessary. Such small portion are denoted compilation unit in the following. For example, a “function” is the typical compilation unit for JavaScript.

FIG. 3 shows a schematic diagram of an example of a script engine for executing JavaScript code. It illustrates the execution flow of V8 JavaScript engine from Google, which is used in the Chrome and Edge browsers, and in Node.js. As is evident from FIG. 3, the script engine is tiered up with profiled data.

In the flow shown in FIG. 3, JavaScript source code 310 is provided to a parser 320, which generates an abstract syntax tree 330 that is provided to a bytecode generator 340. The resulting bytecode is provided to an interpreter 350, which generates a profile, i.e., profiling data 360, which is provided to JIT compilation 370. The output of the bytecode generator 340 is further used to improve or optimize the JIT compilation 370. The JIT compilation 370 yields optimized code 380, which is deoptimized and provided to the interpreter 350.

For a given compilation unit, V8 starts its execution by interpreting the bytecodes, and collecting necessary profiles, mostly about hit counts of each code block and actual types of variables. When it considers the code is hot (i.e., is used often and is thus to be compiled using JIT compilation), and profiles are sufficient and stable (i.e., the execution is in steady state), JIT compilation for that compilation unit is triggered, with the JIT compilation utilizing the profiles to generate the optimized code by specialization & speculation.

As the compilation unit is written in a dynamic script language, the profiles are source code to source code, run-to-run, and steady state to steady state-specific. In other words, the profiles are different for different source codes, and even for the same source code, the profiles can be different among different runs. Even within the same run, the profile can change from time to time. Partially due to this, in many concepts, these profiles are only dynamically collected by the script engines during each run, on the fly and from scratch. The profiles are generally also discarded after the current run is finished. In effect, the profiles are not reused.

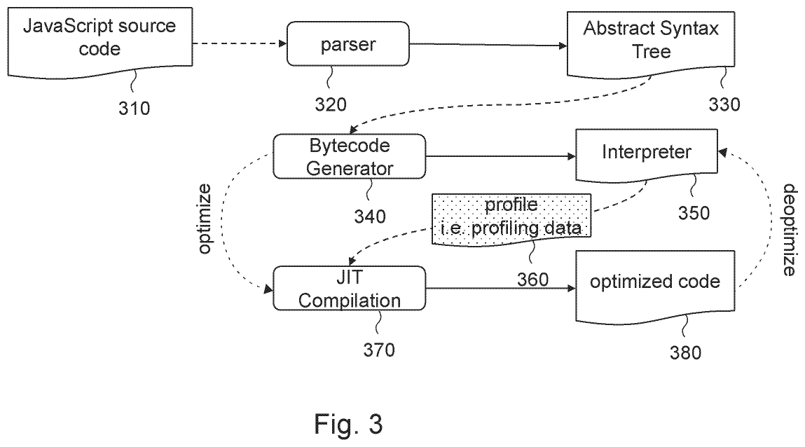

This has at least the following three drawbacks, as is illustrated in FIG. 4. The proposed concept may address one or more of the following drawbacks. FIG. 4 shows a schematic diagram of an example illustrating drawbacks of profiling in a script engine. In FIG. 4, a time-axis is shown, indicating the time of the execution, and therefore also the number of iterations of a loop.

The flow in FIG. 4 starts with code (“let x=a+b”) of a compilation unit 410, such as loop body. At this point, the code is generic, such that all possible types of a and b are handled. At the startup, e.g., iterations 1 to N₁, a warm-up phase 420 can be observed, where the initial profiles 430 are collected. This leads to drawback 1, the “warm-up” at startup, which impacts the responsiveness. It takes time to collect the profiles because related information can only be drawn after there is sufficient historical execution of corresponding code. Therefore, the “warm-up” phase is required to eventually trigger the JIT compilation to generate improved or optimized code.

In modern JavaScript engines (e.g., V8 from Google, SpiderMonkey from Mozilla, and JSC (JavaScriptCore) from Apple), this is denoted “tier-up”—the engines may have multiple tiers of compilation, each requiring a different level of comprehensiveness of profiles, confidence of steadiness of the state, and hotness of the code. When the code is hot enough and related profiles are ready enough, they enter the next level tier with more advanced compilation for more optimized code. As a result, the most improved or optimized code may take a long “warm-up” phase to get enough profiles and tier up multiple times.

The profiles 430 of steady state 1 are now used for iterations N₁+1 to N₂ 440. During these iterations, improved or optimized code 445 is used where a and b are known as integers. However, at N₂, the types of a and/or b may change, leading to a new steady state for iterations N₂+1 to N₃ 450. After iteration N₃, the profiles of this unit of steady state 2 460 are collected and can be used for iterations N₃+1 to N₄ 470. In this steady state, the improved or optimized code 475 is based on the assumption that a and b are string.

This leads to drawback 2, another “warm-up” during the execution due to switch of steady states, which impacts performance. The profiles from existing historical execution may fail to represent the future execution. For example, a and b in above mentioned example may be integers in the profile collection phase during start-up. The improved or optimized code 445 generated for this code block is based on this profile. But after a while, both a and b may change to be always string. Or even worse, the code may be programmed in a pattern that the types of a and b switch between integer and string every 1000 iterations inside a loop.

Many script engine handle this by a technique denoted de-optimization. In case they see that the current steady state is changing, and consequently the current profile and speculation is not correct anymore, they generally discard the optimized & specialized code, and restart the profile collection to update the profile and heuristics. This generally has a significant performance penalty because it not only leads to recovery costs but also adds additional “warm-up” into the execution—each “warm-up” intends to identify a new steady state. Such penalty may be unacceptable if the steady states keep changing.

A third drawback relates to coarse profiles being collected in “warm-up” due to a limited number of iterations, which may lead to sub-optimally generated code. In languages that require a separate offline compilation, such as C/C++/Java etc., the profile can be collected as comprehensive and extensive as possible because it is one-time occurrence-no additional compilation may be required for compiled and shipped binaries. It is usually desirable to perform a very heavy profile collection and compilation to generate the binary as optimal as possible, and then widely distribute it to end users of large scale.

However, the profiling and compilation is part of execution time for script engine. Tradeoffs have to be very carefully balanced. In general, the script engine is often limited to collecting a limited set of information that has the highest ROI (Return on Investment) to guide JIT.

This is because profile collection and analysis itself has overhead and more comprehensive profile collection leads to negative impact to applications' overall performance. As a result, many script engines usually only collect hit counts of functions/loops, and types of variables. They often do not collect other information such as branch taken vs. non-taken ratio, indirect jump targets etc. which is widely used in traditional PGO and contributes significantly to performance gain. Moreover, the script engine might only collect profiling data in the very short “warm-up” period to conclude a steady state. This is because the script engine may desire to execute the improved or optimized code as early as possible. Thus, the profile is often generated as early as possible as well, to trigger the compilation that depends on it earlier.

As mentioned above, in static languages, PGO can be used to improve or optimize the compiled code. PGO is a well-established optimization technology for static/managed languages that has a separate and explicit compilation step to generate the distributable binaries. It is supported by compilers such as LLVM (Low-Level Virtual Machine)/GCC (GNU Compiler Collection) etc.

PGO usually comprises two tasks. The first task comprises running the target application in typical usage scenarios and collect the profiles by instrumentation or from sampling data. In the second task, the PGO re-compiles the application using the heuristics from these profiles. Thus, the finally generated code usually is improved because it uses the information representing the typical usages.

However, PGO is only used for offline compilation rather than JIT. The profiles consequently are not shipped with the application. In dynamic script languages, the script engine needs to recompile the scripts for every execution and still has to re-collect the profile from scratch every time. Furthermore, PGO generally only yields one profile, but due to the various dynamics of script language, the profile can be quite different between different steady states during the execution so one profile might not fit all of them.

Another technique being used in some concepts relates to type annotation for dynamic script languages. Of the information collected in the profiles, the type of variables is one of the most important. There are some concepts of script language extensions that let developers manually annotate the type in the source code. For example, a technique called “asm.js” allows JavaScript developers to write code like “let x=a|0+b|0”. In this technique, the code requires that variable a is combined, using a bit- or operation, with zero before it is added to b. This provides a hint that “+” is an integer add and the JIT of script engine may speculate and create a specialized binary for it.

Another technique is the so-called TypeScript from Microsoft that extends JavaScript's grammar, allowing developer to declare type when defining the variables. However, this information is mostly used in tools such as the IDE (Integrated Development Environment) to do static type checks and hints etc. Eventually, the application is still shipped as JavaScript (without the annotations), thus such information is discarded and not taken by script engine. Type annotation may improve the situation a little bit, but it requires additional efforts from developers to manually provide it explicitly, instead of being automatically collected. Furthermore, such annotations are generally used for developer tools, and not fed into script engines to guide the JIT. Moreover, type annotation has certain constraints. In particular, it limits the dynamics of the script language. For example, it does not allow the change of the type of variable/object, which is an essential feature contributing to script language's productivity, e.g., duck typing vs. template/generic programming of static languages.

Moreover, some concepts provide approaches for distributing addition information with the application written in dynamic script languages. For example, source maps may be used to ship debug symbols of scripts. For web applications created by JavaScript, a JSON (Java Script Object Notation) formatted file can be shipped along with the minified/obfuscated JavaScript files. This file may encode symbols for the shipped JavaScript to map back to the original source code. Modern browsers may automatically fetch and load such source maps, if possible, when developers start a debug session. However, source maps only focus on debug symbols and do not help compilation of scripts.

Modern browsers can also cache some temporary code generated by the script engine so that it can be reused next time. Typically, bytecode for interpreter may be cached so the script engine does not need to parse the raw JavaScript for future execution. In academia, the caching of JITted code is considered as well. However, the caching of bytecodes etc. might only reuse the code generated for one steady state (typically the initial or final state).

Analog to shipping debug symbols along with application for debugging purpose, the proposed concept is based on bundling (e.g., “shipping”) profiles together with the application code and using them to speculatively guide the JIT compilation of dynamic script languages.

In various examples, the profiles are state-based, by associating profiled data with the respective steady states and recording the state transitions. In effect, the script engine may be enabled to predict the upcoming steady state and speculatively guide JIT compilation with corresponding profiled data.

In general, the profiles may be expressed in a script engine-agnostic manner. For example, the profiled data may be mapped to source code rather than mapped to JIT implementation-specific internal representations. This makes the profiles redistributable in large scale and may significantly benefit the libraries (e.g., React, Tensoflow.js etc.) and applications (e.g., Google Meet).

For example, the proposed concept may significantly benefit the end users because the responsiveness and overall performance of the applications written in dynamic script languages may be significantly improved, by mitigating the above-mentioned drawbacks of generation and usage of profiles in script engines. Furthermore, the usage of profiles may improve the ability of script engines of utilizing underlying hardware features based on much more comprehensive characteristics of the application provided in profiles. Moreover, the proposed concept may equip developers of libraries (e.g., React, etc.) and applications with a mechanism for accelerate their products, by allowing them to ship profiles to guide the script engine. Such profiles may be collected easily by collecting them from typical executions before shipped out, or by converting the annotations (e.g., type information in TypeScript).

In the following, an example of an overall architecture of the proposed concept, followed by more detailed explanation of several key components are provided.

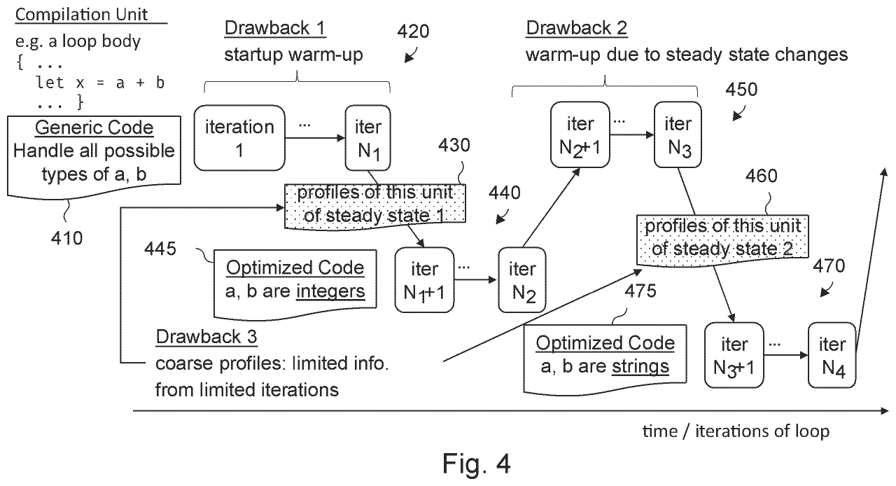

FIG. 5 shows a schematic diagram of an example of an overall flow of profiles at a developer and an end user. FIG. 5 may illustrate the high-level components and flow at both developer side and end user side.

At the developer side, e.g., the apparatus 20, device 20, method and computer program of FIGS. 2a and 2b, after finishing the development of the application or libraries (510) in a given script languages as usual, e.g., a web app being based on JavaScript, with the proposed concept, developers may generate some profiles to publish and ship. The profiles may be generated from multiple places before the lib/app is shipped to end users.

First, developers may run the lib/app in many various typical scenarios from the perspective of end users. Unlike traditional script engines, which perform lightweight profiling for the compilation units it touches, the proposed concept may instead define a comprehensive mode for profiling (515). Under this mode, the script engine may collect anything of relevance, such as type information, branch taken data, cache behavior etc. It may collect such information by instrumentation or sampling. As this profiling happens at the developer side, such heavy but comprehensive profiling is feasible in order to generate much richer profiling data, without worrying about the overhead and impact to user experience. This may resolve or reduce the third drawback previously discussed beginning. Such profiling data may be exported (520) by script engine, to profiles (525), e.g., in a script engine-neutral format.

Secondly, if the library or application is originally programmed with annotations, such annotations may also be extracted (522) and converted to profiles (525) by a transpiler (517) that is enhanced by the proposed concept. A typical example is that the type information in TypeScript may be extracted into profiles, so the script engine does not need to determine the types by profiling and speculating in each run at the end user side.

In various examples, the profiles (525) may be indexed by State and Compilation Unit. State may be used here, because for a compilation unit, as explained earlier, multiple steady states may be reached, either during one execution, or between multiple different executions for various usage scenarios. For example, a typical compilation unit in JavaScript is a function or a loop body. More details about how state is defined and how profiles are formatted will be explained subsequently.

In various examples, for one library or application, many profiles may be generated for multiple tuples of (State, Compilation Unit). Even for the same tuple of (State, Compilation Unit), multiple profiles may be generated, which may be aggregated and merged incrementally.

In some examples, the proposed concept may record the state transition information into the profiles. For example, for a given compilation unit X under state S, the concept may record which are the preceding states of X, that jump to S and on which conditions. It may also record the succeeding states of X and the conditions triggering the switch as well.

The profiles are packaged and distributed together (e.g., bundled) with the application/library (510) and delivered to the end user. The actual package and dispatch methodology is implementation-specific. For example, it may follow similar methodology as source maps, so desired profiles for a particular compilation unit may be fetched on-demand (lazily) until it is requested.

At the end user side, e.g., the apparatus 10, device 10, method and computer program of FIGS. 1a to 1c, the script engine may still conduct its own lightweight profiling data collection (550) as usual and generate its own profile (555) for certain compilation units and reaches a given steady state. This behavior might not have changed and may be almost the same with or without the proposed concept.

Meanwhile, the proposed concept may enhance the script engine with respect to profiles by caching (560) its own profiles collected at the local side for future use, and merging (565) the profiles from multiple sources into a local database (575) for querying.

The cache (560) may be helpful, as the profiles shipped by developers are collected on predicted typical usage scenarios and usually cannot cover all situations. Each client may have its own special and unexpected usages which may result in undiscovered steady states and state transitions. The local cache may reflect the behavior for each individual client and may thus help generate the most suitable profiles for a given user.

Merging is used because the profiling may be aggregated from multiple sources, i.e., profiles shipped by developers, profiles cached from previous executions in this client, and profiles collected on the fly but the script engine on the current execution. The actual merge algorithm is implementation specific. For example, a naïve implementation may simply equally weight the profiles from various sources and complement the missing information with each other.

If there is a conflict, i.e., a different branch taken ratio of an “if” statement in the same (Compilation Unit, State) index, the script engine may pick up the most likely one or the most recent one.

During the entire execution (590), for any compilation unit, the script engine may keep predicting (595) its state. The prediction algorithm is also implementation specific. Some examples of the prediction algorithm are discussed at a later stage.

Once the script engine foresees (595) that a compilation unit X is about to enter steady state S, it may query (570) the profile database (575) with the index (X, S) to acquire the suitable profile if any. If such profile is available, valid, and sufficient, the script engine may speculatively trigger the JIT compilation (580) for this compilation unit X, with the acquired profile applied to guide the JIT.

Later, in an ideal case, the compilation unit may enter steady state S as expected. At this moment, the optimized code may be usually already generated by JIT with the correct profiles, so there is no warm-up time and no wait for the compilation, thus mitigating the drawback 2 mentioned above.

Among all possible states for a given compilation unit, the most likely initial state may be determined from the profiles. This may be done by looking at the state transitions of the states. Furthermore, by looking at the timestamps and ordering the hit counts of all compilation units in the profile database, the set of compilation units that are frequently executed at the beginning of the application can be determined. With these two heuristics, the script engine may speculatively trigger the JIT engine at the very beginning for the initial set of compilation units and guide the JIT with the profile of their initial state respectively. If the speculation succeeds in the ideal case, drawback 1 may be mitigated.

In various examples, the above-mentioned prediction and speculative JIT compilations may be done in parallel in the background. The script engine may perform smart scheduling dynamically. If there is limited computation and memory resource available, such speculation may be performed in a conservative manner, and the worst case may be similar to the approach without the proposed concept at all. However, if the script engine has access to idle processors and affordable memory and power budgets, it may try more aggressive speculation to get certain compilation units JITted earlier with predicted states. It may waste some power consumption if the speculation fails, but the performance penalty may be considered negligible because it runs at background instead of interfering with the critical path.

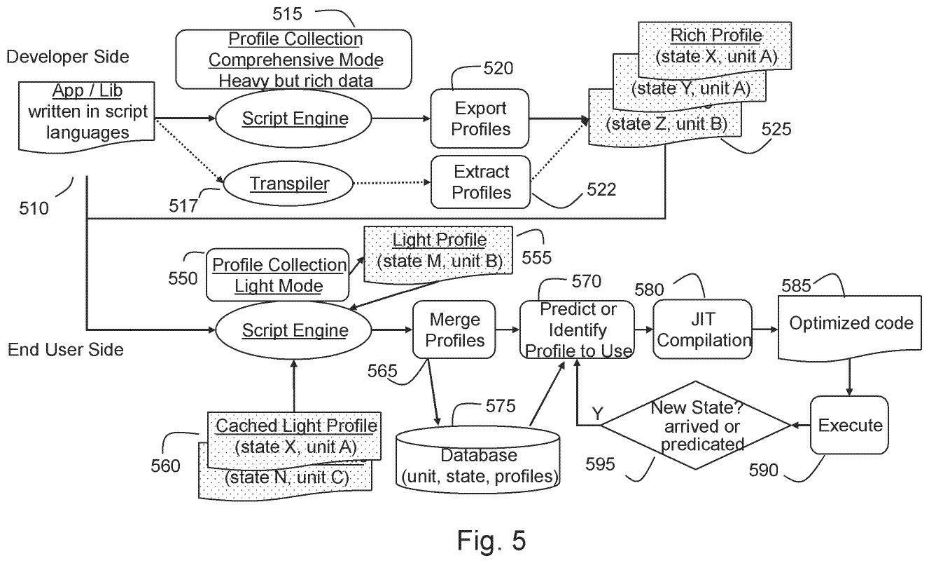

In various examples, with the techniques applied at both developer and end user side, the three drawbacks may be mitigated. FIG. 6 illustrates the elimination of the three drawbacks in an ideal case. FIG. 6 shows a schematic diagram of an example illustrating how drawbacks can be overcome with respect to profiling in a script engine. While in iterations 1 to M₁ 620, similar to the example shown in FIG. 4, the generic code 610 (which handles all possible types of a and b) is used, the startup warm-up may end much earlier, and the improved or optimized code may be used much earlier. M₁, which is the time to JIT, may be much shorter than N₁ used in FIG. 4. Profiles 630 of the predicted state are used to guide the JIT 640, which assumes a and b to be integers. The JITted code is used from iteration M₁+1. Shortly before iteration M2 650, a state change is predicted 660, which leads to JIT 680 using the profiles 670 of the predicted/identified change, which are used for iterations M₂+1 through M₃ 690. Drawback 2 may also be resolved, as, in the ideal case, no warm-up might be necessary due to steady state changes. Furthermore, drawback 3 may be resolved, as comprehensive profiles with rich information may be collected at the developer side.

Some aspects of the present disclosure relate to redistributable and script-engine-agnostic representation of profiles. To ship (e.g., bundle) the profiles along with the library/application in large scale, the profiles may be expressed in a way that they can be distributed to end users who may run different script engines from any vendor in any version. In particular, the profiles may be completely agnostic to script engines, so that each script engine does not need to rely on knowledge of other engines to understand (e.g., parse) the profiles redistributed. Moreover, the script engine may be free to use or not use the profiles. i.e., legacy script engines may be able to ignore the profiles and not use them at all, while more advanced script engines may be able to fully exploit the information in profiles to generate better code. Some other script engines may pick up some of the profiles, but not all of them. Moreover, script engines should still function well even if the expected profiles are missing. The two latter aspects are rather easy to satisfy, by keeping in mind that the profiles are “additional” complimentary information, but not “essential” information that must be supplied.

FIG. 7 shows a flow diagram of an example of a flow for loading separated profiles from a script. As shown in FIG. 7, for a script 710, e.g., x.js, its profiling information may be stored in separate files 720, e.g., <x.profiles>. The file names may be different and follow other naming conventions. A legacy script engine may simply load x.js as usual. It may ignore the <x.profiles> completely, neither fetching nor loading them. A script engine that adopts the proposed concept, when loading 740 x.js, it will try to fetch and load its profiles as well, by checking 750 whether <x.profiles> exists, and, if yes, load 760<x.profiles> for future use, and if no, proceed 770 as usual, with no special actions required.

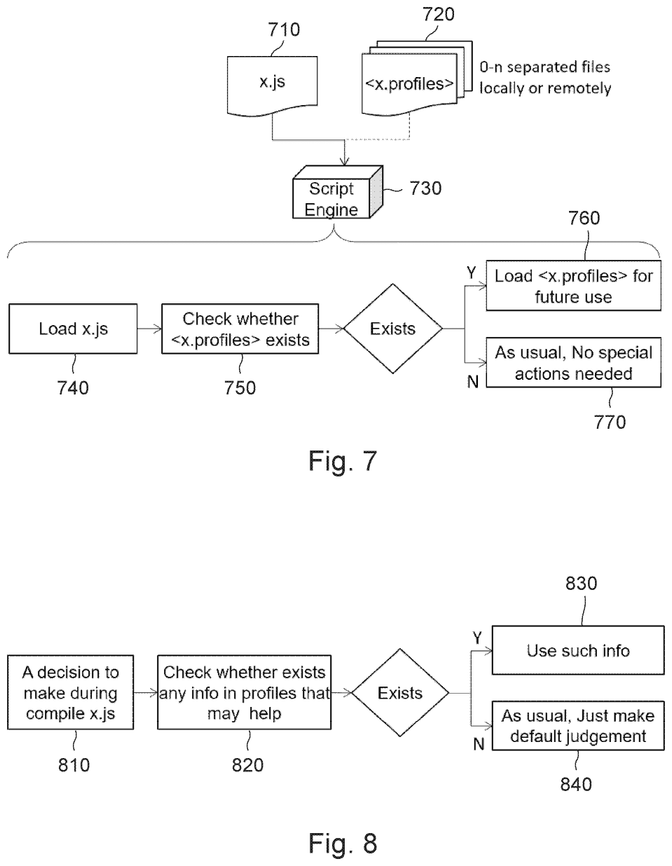

FIG. 8 shows a schematic diagram of an example of a flow for deciding on whether or not to use information from a profile during compilation. As FIG. 8 illustrates, during JIT compilation 810 (580 in FIG. 5), there may be multiple dynamic decisions to make, e.g., which type of a particular variable to speculate with. A script engine that uses the proposed concept may query 820 such information from the identified profiles (570 in FIG. 5). If any useful information is available, it may be used 830 used to generate better code. However, if the script engine does not find any useful information, it may simply fallback 840 to normal/legacy path and generate the code as usual as if there is no such proposed concept.

The above requirements 2) and 3) may be naturally satisfied by above mechanisms.

In the following, some examples are presented that focus on requirement 1), i.e., expressing the profiles in script engine agnostic way. A major insight here is to make the script file (e.g., a JavaScript file or a Python file) script engine agnostic. The proposed concept may map the information in the profiles back to script files and associate it with tokens/lines of the original source code written in the script language. Thus, the profiles might only depend on script files, and might not relate script engine internals. In this respect, the profiles may be implemented similar as Debug Symbols (while not the same), and so be script engine agnostic.

Traditional profiles, e.g., these used in PGO in traditional compilers such as LLVM or GCC, use two kinds of formats. A first format is sampling-based. In the first format, the profiles are raw PMU (performance monitoring unit) events. For example, the profiles may record a branch taken event at time X for IP (instruction pointer) P. When applying such profiles, the compiler may map the IP to a position in the source files by using debug symbols. A second format is instrumentation-based. In this case, the profiles may store the information for the internal representations of the compiler, e.g., it may record the enter and quit of a function, or a basic block etc. Either of these formats might not be applicable to dynamic script languages for redistribution purposes. Sampling-based formats may require debug symbols. However, this might not be feasible for JIT because the code is generated on the fly and may vary between runs. Instrumentations may map the information to internal representations which are compiler/JIT specific. In the proposed concept, no matter whether the profiling data is collected by sampling or by instrumentation, the representation may be mapped to and associated with original source code written in the respective script.

For example, as illustrated in FIG. 9, each piece of profiling data, such as entering functions, type information, branch takens etc., may be associated with its corresponding position in the source code of the library/application, which is written in dynamic script languages, along with the relative timestamp when this information is collected. The profiles may be serialized into any text or binary format, for example, JSON text also as illustrated in FIG. 9.

The left side of FIG. 9 shows the source code 910 of the compilation unit, and the right side shows the profile 920 of the compilation unit. In the example, the profile has four columns—source location (expressed as filename:line number:character number, a type of the profile information (e.g., function enter, variable type, branch, or function leave), a payload (e.g., integer as variable type, branch taken for the branch, and a timestamp column, indicating the timestamp when the respective profile item is relevant. For example, the first entry of the profile relates to line 10 of test.js, at character number 10, with the type function enter with a timestamp of 10000. The second entry of the profile relates to line 10 of test.js, character number 15, with the type variable type, payload integer and timestamp 10100. The second entry of the profile relates to line 10 of test.js, character number 18, with the type variable type, payload integer and timestamp 10100. The fourth entry of the profile relates to line 12 of test.js, character number 3, with the type branch, payload taken and timestamp 11000. The last entry of the profile relates to line 18 of test.js, character number 1, with the type function leave and timestamp 20000.

Each script engine may treat the profiles as additional “annotations” to tokens in the source code. Different script engines may parse and use them in whatever way they prefer. Typically, the following process may be used. First, the original source code may be loaded and parsed as AST (Abstract Syntax Tree). Then, the information in the profiles may be parsed and become additional properties of the nodes of the AST tree. Per design and implementation of each script engine, the AST nodes, as well as the associated profiles property, may be converted to lower-level internal representations, e.g., bytecodes or compiler intermediate representations. However, each script engine may have its own design and implementation to handle such script engine agonistic profile expressions.

In the following, an example of a definition of a state of a compilation unit is provided. Each state (steady or not) of the compilation unit may be represented as a n-dimension vector <v₁, v₂, . . . , vₙ>. Each element of the vector may be considered a feature. Such features may be script engine-agnostic, so that the information remains redistributable in large scale. The actual features to use are implementation specific. There are at least two mechanism to define these features. For example, such features may relate to manually selected characteristics. For example, a possible implementation may pick up the following features a) current type of variable X in the application, b) whether the function F has been executed more than 1000 times, c) whether the function F has been improved or optimized for this state before, d) whether the recent branch taken ratio of an “if” statement is greater than 0.7, e) whether the recent cache miss ratio of this unit is greater than 0.01, of f) whether a total number of executed functions (not only this one) is greater than 10000. The vector (thus the underlying features) may be automatically calculated by a deep learning model, e.g . . . , using embedding technology which is widely used in NLP (Natural Language Processing). The well-trained model may take a lot of raw information (associated with source code, script engine neutral) as input and return a vector to represent the state.

If the state is defined a n-dimension vector, the distance (or similarity) of two states of the same compilation unit may be measured. The algorithm to do so is implementation specific, with one possible algorithm being based on the Euclidean distance. Eventually, all such profiles may be merged into a local database (575) as mentioned above, as illustrated in FIG. 10 below. When querying (Compilation Unit, State) from the database, the database might not necessarily return the entry with the exact match, instead, it may return all states of that compilation that are close enough to the query term, e.g., within a threshold of distance. FIG. 10 shows a table of an example of a database of compilation units, states, and profile. The database comprises a plurality of entries, with each entry comprising a plurality of fields, such as a field specifying the compilation unit (e.g., U₁ or U₂ in the example of FIG. 10), a field specifying an identifier of a state (S₁ and S₂ in FIG. 10) and values vₓ of features 1 to N defining the state. Each entry may further comprise a field containing the profiling data, e.g., as shown in FIG. 9, and optionally a field comprising a reference to a preceding state and a field comprising a reference to succeeding state. In effect, the implementation may have the preceding state and succeeding state captured in profiles, as illustrated in last two columns of FIG. 10 as well. This helps the prediction of state transitions as will be elaborated in next section.

In the following, the state prediction is discussed. In the proposed concept, the penalty of wrong speculation to application's performance may be considered to be trivial, because the JIT compilation on the profile of the wrong state that is triggered earlier may be done in the background and might not inference the main critical path. However, more accurate prediction of the next state to arrive may still be important because it not only improves the performance by effectively mitigating drawback 2 but may also reduce the wasted power consumption due to wrong speculation. The actual prediction of state transitions is implementation specific. In the following, an example of a possible design is introduced for illustration purposes.

In this design, first, a state transition diagram may be built for each compilation unit, e.g., as shown in FIG. 11. FIG. 11 shows a state diagram of an example of state transitions of a compilation unit. In FIG. 11, state A transitions to either state B or state C. State B transitions to state D. State C transitions to state E and then back to state A. This diagram may be built from information from the profile database, which may comprise fields containing references to preceding and succeeding state, as illustrated in the table of FIG. 10. Even if the preceding or succeeding states are not provided, the profiles may be partially analyzed by ordering the timestamps (or number of instructions executed) associated with each state. This may be less accurate or fine grained as above but may usually be sufficient.

During the execution, according to current state the compilation unit resides in, the script engine may reference the state transition diagram to determine the next state to use. If there are multiple succeeding states, e.g. A may have B and C as succeeding states in different scenarios, the script engine may use various strategies, e.g., picking the state which is used more often, or picking the state which has been entered recently, or picking them all, triggering JIT for the different states, and switching to the right one later, etc. The state transition diagram may also help in determining the initial state to mitigate drawback 1. For example, the diagram of FIG. 11 implies that state A is the initial state of this compilation unit that the JIT should start with.

Various examples of the proposed concept are based on packaging and shipping the profiles together with the application and libraries written in script languages. The supplied profiles may be used in addition to profiles collected during actual execution.

More details and aspects of the concept for generating and providing profiles are mentioned in connection with the proposed concept or one or more examples described above or below (e.g., FIG. 1a to 2b). The concept for generating and providing profiles may comprise one or more additional optional features corresponding to one or more aspects of the proposed concept, or one or more examples described above or below.

In the following, some examples of the proposed concept are given:
An example (e.g., example 1) relates to an apparatus (10) for executing code written in a dynamic script language, the apparatus comprising processing circuitry (14) configured to obtain code written in the dynamic script language. The processing circuitry is configured to obtain one or more profiles for accelerating an execution of the code, the one or more profiles being bundled with the code. The processing circuitry is configured to execute the code based on the one or more profiles.
Another example (e.g., example 2) relates to a previously described example (e.g., example 1) or to any of the examples described herein, further comprising that the one or more profiles comprise profiling data with respect to dynamic aspects of the code.
Another example (e.g., example 3) relates to a previously described example (e.g., one of the examples 1 to 2) or to any of the examples described herein, further comprising that the one or more profiles comprise information on variable types of variables being used in the code.
Another example (e.g., example 4) relates to a previously described example (e.g., example 3) or to any of the examples described herein, further comprising that the processing circuitry is configured to execute the code with the variable types specified by the information on the variable types.
Another example (e.g., example 5) relates to a previously described example (e.g., one of the examples 1 to 4) or to any of the examples described herein, further comprising that the one or more profiles comprise metrics on one or more of a likelihood of one or more branches being taken, an approximate number of invocations of a function, a cache miss ratio, and a number of functions being executed.
Another example (e.g., example 6) relates to a previously described example (e.g., example 0) or to any of the examples described herein, further comprising that the processing circuitry is configured to adjust the execution of the code based on the metrics.
Another example (e.g., example 7) relates to a previously described example (e.g., one of the examples 1 to 6) or to any of the examples described herein, further comprising that each profile is associated with a steady state of the execution of the code.
Another example (e.g., example 8) relates to a previously described example (e.g., example 7) or to any of the examples described herein, further comprising that dynamic aspects of the code are quasi-static during a steady state of the execution of the code.
Another example (e.g., example 9) relates to a previously described example (e.g., one of the examples 7 to 8) or to any of the examples described herein, further comprising that the execution of the code transitions from a steady state to another steady state if a dynamic aspect of the code changes during execution of the code.
Another example (e.g., example 10) relates to a previously described example (e.g., example 9) or to any of the examples described herein, further comprising that the execution of the code transitions from a steady state to another steady state if at least one of a type of a variable, a metric on a likelihood of one or more branches being taken, a metric on an approximate number of invocations of a function, a metric on a cache miss ratio and a metric on a number of functions being executed changes during execution of the code.
Another example (e.g., example 11) relates to a previously described example (e.g., one of the examples 1 to 10) or to any of the examples described herein, further comprising that the processing circuitry is configured to obtain a plurality of profiles that are bundled with the code, with each profile being associated with a steady state of an execution of the code.
Another example (e.g., example 12) relates to a previously described example (e.g., example 11) or to any of the examples described herein, further comprising that the processing circuitry is configured to obtain information on one or more transitions between the steady states of the execution of the code that is bundled with the code, and to select a profile of the plurality of profiles based on the information on the one or more transitions between the steady states of the execution.
Another example (e.g., example 13) relates to a previously described example (e.g., one of the examples 1 to 12) or to any of the examples described herein, further comprising that the one or more profiles are defined according to a script execution engine-agnostic format.
Another example (e.g., example 14) relates to a previously described example (e.g., one of the examples 1 to 13) or to any of the examples described herein, further comprising that the processing circuitry is configured to request the code from a server as a file having a filename, and to request the one or more profiles from the server as a file having a filename that is derived from the filename of the code.
Another example (e.g., example 15) relates to a previously described example (e.g., one of the examples 1 to 14) or to any of the examples described herein, further comprising that the processing circuitry is configured to perform profiling during execution of the code to determine one or more further profiles, to merge the one or more profiles with the one or more further profiles, and to execute the codes based on the merged profiles.
An example (e.g., example 16) relates to a computer system (100) comprising the apparatus (10) for executing code written in a dynamic script language according to one of the previous examples, e.g., according to one of the examples 1 to 15.
An example (e.g., example 17) relates to an apparatus (20) for providing code of a dynamic scripting language, the apparatus comprising processing circuitry (24) configured to obtain the code written in the dynamic scripting language. The processing circuitry is configured to generate one or more profiles for accelerating an execution of the code. The processing circuitry is configured to bundle the code with the one or more profiles. The apparatus (20) comprises provide the code bundled with the one or more profiles.
Another example (e.g., example 18) relates to a previously described example (e.g., example 17) or to any of the examples described herein, further comprising that the processing circuitry is configured to generate the one or more profiles by executing the code.
Another example (e.g., example 19) relates to a previously described example (e.g., one of the examples 17 to 18) or to any of the examples described herein, further comprising that the one or more profiles comprise profiling data with respect to dynamic aspects of the code.
Another example (e.g., example 20) relates to a previously described example (e.g., one of the examples 17 to 19) or to any of the examples described herein, further comprising that the processing circuitry is configured to determine variable types of variables being used, and to include information on the variable types of the variables being used in the code in the one or more profiles.
Another example (e.g., example 21) relates to a previously described example (e.g., one of the examples 17 to 20) or to any of the examples described herein, further comprising that the processing circuitry is configured to determine metrics on one or more of a likelihood of one or more branches being taken, an approximate number of invocations of a function, a cache miss ratio, and a number of functions being executed, and to include the metrics in the one or more profiles.
Another example (e.g., example 22) relates to a previously described example (e.g., one of the examples 17 to 21) or to any of the examples described herein, further comprising that the processing circuitry is configured to determine one or more steady states during the execution of the code, and to generate the one or more profiles based on the one or more steady states, so that each profile is associated with a steady state of the execution of the code.
Another example (e.g., example 23) relates to a previously described example (e.g., example 22) or to any of the examples described herein, further comprising that the processing circuitry is configured to, if the processing circuitry determines a plurality of steady states, generate a plurality of profiles, with each profile being associated with a steady state of an execution of the code.
Another example (e.g., example 24) relates to a previously described example (e.g., example 23) or to any of the examples described herein, further comprising that the processing circuitry is configured to determine one or more triggers for one or more transitions between the plurality of steady states, to determine information on the one or more transitions between the steady states based on the one or more triggers, and to bundle the information on the one or more transitions with the code.
Another example (e.g., example 25) relates to a previously described example (e.g., one of the examples 17 to 24) or to any of the examples described herein, further comprising that the processing circuitry is configured to generate the one or more profiles according to a script execution engine-agnostic format.
Another example (e.g., example 26) relates to a previously described example (e.g., one of the examples 17 to 25) or to any of the examples described herein, further comprising that the processing circuitry is configured to provide the code as a file having a filename, and to provide the one or more profiles as a file having a filename that is derived from the filename of the code.
An example (e.g., example 27) relates to a computer system (200) comprising the apparatus (20) for providing code of a dynamic scripting language according to one of the previous examples, e.g., according to one of the examples 17 to 26.
An example (e.g., example 28) relates to a system comprising the apparatus (10) for executing code written in a dynamic script language according to one of the previous examples, e.g., one of the examples 1 to 15 and the apparatus (20) for providing code of a dynamic scripting language according to one of the previous examples, e.g., one of the examples 17 to 26.
An example (e.g., example 29) relates to a system comprising the computer system (100) according to a previous example, e.g., example 16 and the computer system (200) according to a previous example, e.g., example 27.
An example (e.g., example 30) relates to a device (10) for executing code written in a dynamic script language, the device comprising means for processing (14) configured to obtain code written in the dynamic script language. The means for processing (14) is configured to obtain one or more profiles for accelerating an execution of the code, the one or more profiles being bundled with the code. The means for processing (14) is configured to execute the code based on the one or more profiles.
Another example (e.g., example 31) relates to a previously described example (e.g., example 30) or to any of the examples described herein, further comprising that the one or more profiles comprise profiling data with respect to dynamic aspects of the code.
Another example (e.g., example 32) relates to a previously described example (e.g., one of the examples 30 to 31) or to any of the examples described herein, further comprising that the one or more profiles comprise information on variable types of variables being used in the code.
Another example (e.g., example 33) relates to a previously described example (e.g., example 32) or to any of the examples described herein, further comprising that the means for processing is configured to execute the code with the variable types specified by the information on the variable types.
Another example (e.g., example 34) relates to a previously described example (e.g., one of the examples 30 to 33) or to any of the examples described herein, further comprising that the one or more profiles comprise metrics on one or more of a likelihood of one or more branches being taken, an approximate number of invocations of a function, a cache miss ratio, and a number of functions being executed.
Another example (e.g., example 35) relates to a previously described example (e.g., example 0) or to any of the examples described herein, further comprising that the means for processing is configured to adjust the execution of the code based on the metrics.
Another example (e.g., example 36) relates to a previously described example (e.g., one of the examples 30 to 35) or to any of the examples described herein, further comprising that each profile is associated with a steady state of the execution of the code.
Another example (e.g., example 37) relates to a previously described example (e.g., example 36) or to any of the examples described herein, further comprising that dynamic aspects of the code are quasi-static during a steady state of the execution of the code.
Another example (e.g., example 38) relates to a previously described example (e.g., one of the examples 36 to 37) or to any of the examples described herein, further comprising that the execution of the code transitions from a steady state to another steady state if a dynamic aspect of the code changes during execution of the code.
Another example (e.g., example 39) relates to a previously described example (e.g., example 38) or to any of the examples described herein, further comprising that the execution of the code transitions from a steady state to another steady state if at least one of a type of a variable, a metric on a likelihood of one or more branches being taken, a metric on an approximate number of invocations of a function, a metric on a cache miss ratio and a metric on a number of functions being executed changes during execution of the code.
Another example (e.g., example 40) relates to a previously described example (e.g., one of the examples 30 to 39) or to any of the examples described herein, further comprising that the means for processing is configured to obtain a plurality of profiles that are bundled with the code, with each profile being associated with a steady state of an execution of the code.
Another example (e.g., example 41) relates to a previously described example (e.g., example 40) or to any of the examples described herein, further comprising that the means for processing is configured to obtain information on one or more transitions between the steady states of the execution of the code that is bundled with the code, and to select a profile of the plurality of profiles based on the information on the one or more transitions between the steady states of the execution.
Another example (e.g., example 42) relates to a previously described example (e.g., one of the examples 30 to 41) or to any of the examples described herein, further comprising that the one or more profiles are defined according to a script execution engine-agnostic format.
Another example (e.g., example 43) relates to a previously described example (e.g., one of the examples 30 to 42) or to any of the examples described herein, further comprising that the means for processing is configured to request the code from a server as a file having a filename, and to request the one or more profiles from the server as a file having a filename that is derived from the filename of the code.
Another example (e.g., example 44) relates to a previously described example (e.g., one of the examples 30 to 43) or to any of the examples described herein, further comprising that the means for processing is configured to perform profiling during execution of the code to determine one or more further profiles, to merge the one or more profiles with the one or more further profiles, and to execute the codes based on the merged profiles.
An example (e.g., example 45) relates to a computer system (100) comprising the device (10) for executing code written in a dynamic script language according to one of the previous examples, e.g., according to one of the examples 30 to 44.
An example (e.g., example 46) relates to a device (20) for providing code of a dynamic scripting language, the device comprising means for processing (24) configured to obtain the code written in the dynamic scripting language. The means for processing (24) is configured to comprises generate one or more profiles for accelerating an execution of the code. The means for processing (24) is configured to bundle the code with the one or more profiles. The device (20) comprises provide the code bundled with the one or more profiles.
Another example (e.g., example 47) relates to a previously described example (e.g., example 46) or to any of the examples described herein, further comprising that the means for processing is configured to generate the one or more profiles by executing the code.
Another example (e.g., example 48) relates to a previously described example (e.g., one of the examples 46 to 47) or to any of the examples described herein, further comprising that the one or more profiles comprise profiling data with respect to dynamic aspects of the code.
Another example (e.g., example 49) relates to a previously described example (e.g., one of the examples 46 to 48) or to any of the examples described herein, further comprising that the means for processing is configured to determine variable types of variables being used, and to include information on the variable types of the variables being used in the code in the one or more profiles.
Another example (e.g., example 50) relates to a previously described example (e.g., one of the examples 46 to 49) or to any of the examples described herein, further comprising that the means for processing is configured to determine metrics on one or more of a likelihood of one or more branches being taken, an approximate number of invocations of a function, a cache miss ratio, and a number of functions being executed, and to include the metrics in the one or more profiles.
Another example (e.g., example 51) relates to a previously described example (e.g., one of the examples 46 to 50) or to any of the examples described herein, further comprising that the means for processing is configured to determine one or more steady states during the execution of the code, and to generate the one or more profiles based on the one or more steady states, so that each profile is associated with a steady state of the execution of the code.
Another example (e.g., example 52) relates to a previously described example (e.g., example 51) or to any of the examples described herein, further comprising that the means for processing is configured to, if the means for processing determines a plurality of steady states, generate a plurality of profiles, with each profile being associated with a steady state of an execution of the code.
Another example (e.g., example 53) relates to a previously described example (e.g., example 52) or to any of the examples described herein, further comprising that the means for processing is configured to determine one or more triggers for one or more transitions between the plurality of steady states, to determine information on the one or more transitions between the steady states based on the one or more triggers, and to bundle the information on the one or more transitions with the code.
Another example (e.g., example 54) relates to a previously described example (e.g., one of the examples 46 to 53) or to any of the examples described herein, further comprising that the means for processing is configured to generate the one or more profiles according to a script execution engine-agnostic format.
Another example (e.g., example 55) relates to a previously described example (e.g., one of the examples 46 to 54) or to any of the examples described herein, further comprising that the means for processing is configured to provide the code as a file having a filename, and to provide the one or more profiles as a file having a filename that is derived from the filename of the code.
An example (e.g., example 56) relates to a computer system (200) comprising the device (20) for providing code of a dynamic scripting language according to one of the previous examples, e.g., according to one of the examples 46 to 55.
An example (e.g., example 57) relates to a system comprising the device (10) for executing code written in a dynamic script language according one of the previous examples, e.g., according to one of the examples 30 to 44 and the device (20) for providing code of a dynamic scripting language according to one of the previous examples, e.g., according to one of the examples 46 to 55.
An example (e.g., example 58) relates to a system comprising the computer system (100) according to a previous examples, e.g., according to example 45 and the computer system (200) according to another previous examples, e.g., according to example 56.
An example (e.g., example 59) relates to a method for executing code written in a dynamic script language, the method comprising obtaining (110) code written in the dynamic script language. The method comprises obtaining (120) one or more profiles for accelerating an execution of the code, the one or more profiles being bundled with the code. The method comprises executing (160) the code based on the one or more profiles.
Another example (e.g., example 60) relates to a previously described example (e.g., example 59) or to any of the examples described herein, further comprising that the one or more profiles comprise profiling data with respect to dynamic aspects of the code.
Another example (e.g., example 61) relates to a previously described example (e.g., one of the examples 59 to 60) or to any of the examples described herein, further comprising that the one or more profiles comprise information on variable types of variables being used in the code.
Another example (e.g., example 62) relates to a previously described example (e.g., example 61) or to any of the examples described herein, further comprising that the method comprises executing (160) the code with the variable types specified by the information on the variable types.
Another example (e.g., example 63) relates to a previously described example (e.g., one of the examples 59 to 62) or to any of the examples described herein, further comprising that the one or more profiles comprise metrics on one or more of a likelihood of one or more branches being taken, an approximate number of invocations of a function, a cache miss ratio, and a number of functions being executed.
Another example (e.g., example 64) relates to a previously described example (e.g., example 0) or to any of the examples described herein, further comprising that the method comprises adjusting (165) the execution of the code based on the metrics.
Another example (e.g., example 65) relates to a previously described example (e.g., one of the examples 59 to 64) or to any of the examples described herein, further comprising that each profile is associated with a steady state of the execution of the code.
Another example (e.g., example 66) relates to a previously described example (e.g., example 65) or to any of the examples described herein, further comprising that dynamic aspects of the code are quasi-static during a steady state of the execution of the code.
Another example (e.g., example 67) relates to a previously described example (e.g., one of the examples 65 to 66) or to any of the examples described herein, further comprising that the execution of the code transitions from a steady state to another steady state if a dynamic aspect of the code changes during execution of the code.
Another example (e.g., example 68) relates to a previously described example (e.g., example 37) or to any of the examples described herein, further comprising that the execution of the code transitions from a steady state to another steady state if at least one of a type of a variable, a metric on a likelihood of one or more branches being taken, a metric on an approximate number of invocations of a function, a metric on a cache miss ratio and a metric on a number of functions being executed changes during execution of the code.
Another example (e.g., example 69) relates to a previously described example (e.g., one of the examples 59 to 68) or to any of the examples described herein, further comprising that the method comprises obtaining (120) a plurality of profiles that are bundled with the code, with each profile being associated with a steady state of an execution of the code.
Another example (e.g., example 70) relates to a previously described example (e.g., example 69) or to any of the examples described herein, further comprising that the method comprises obtaining (130) information on one or more transitions between the steady states of the execution of the code that is bundled with the code and selecting (140) a profile of the plurality of profiles based on the information on the one or more transitions between the steady states of the execution.
Another example (e.g., example 71) relates to a previously described example (e.g., one of the examples 59 to 70) or to any of the examples described herein, further comprising that the one or more profiles are defined according to a script execution engine-agnostic format.
Another example (e.g., example 72) relates to a previously described example (e.g., one of the examples 59 to 71) or to any of the examples described herein, further comprising that the method comprises requesting (115) the code from a server as a file having a filename and requesting (125) the one or more profiles from the server as a file having a filename that is derived from the filename of the code.
Another example (e.g., example 73) relates to a previously described example (e.g., one of the examples 59 to 72) or to any of the examples described herein, further comprising that the method comprises performing (150) profiling during execution of the code to determine one or more further profiles, merging (155) the one or more profiles with the one or more further profiles and executing (160) the codes based on the merged profiles.
An example (e.g., example 74) relates to a method for providing code of a dynamic scripting language, the method comprising obtaining (210) the code written in the dynamic scripting language. The method comprises generating (240) one or more profiles for accelerating an execution of the code. The method comprises bundling (260) the code with the one or more profiles. The method comprises providing (270) the code bundled with the one or more profiles.
Another example (e.g., example 75) relates to a previously described example (e.g., example 74) or to any of the examples described herein, further comprising that the method comprises generating (240) the one or more profiles by executing (220) the code.
Another example (e.g., example 76) relates to a previously described example (e.g., one of the examples 74 to 75) or to any of the examples described herein, further comprising that the one or more profiles comprise profiling data with respect to dynamic aspects of the code.
Another example (e.g., example 77) relates to a previously described example (e.g., one of the examples 74 to 76) or to any of the examples described herein, further comprising that the method comprises determining (242) variable types of variables being used and including (244) information on the variable types of the variables being used in the code in the one or more profiles.
Another example (e.g., example 78) relates to a previously described example (e.g., one of the examples 74 to 77) or to any of the examples described herein, further comprising that the method comprises determining (246) metrics on one or more of a likelihood of one or more branches being taken, an approximate number of invocations of a function, a cache miss ratio, and a number of functions being executed, and including (248) the metrics in the one or more profiles.
Another example (e.g., example 79) relates to a previously described example (e.g., one of the examples 74 to 78) or to any of the examples described herein, further comprising that the method comprises determining (230) one or more steady states during the execution of the code and generating (240) the one or more profiles based on the one or more steady states, so that each profile is associated with a steady state of the execution of the code.
Another example (e.g., example 80) relates to a previously described example (e.g., example 79) or to any of the examples described herein, further comprising that the method comprises, if the means for processing determines a plurality of steady states, generating (240) a plurality of profiles, with each profile being associated with a steady state of an execution of the code.
Another example (e.g., example 81) relates to a previously described example (e.g., example 80) or to any of the examples described herein, further comprising that the method comprises determining (250) one or more triggers for one or more transitions between the plurality of steady states, determining (255) information on the one or more transitions between the steady states based on the one or more triggers, and bundling (265) the information on the one or more transitions with the code.
Another example (e.g., example 82) relates to a previously described example (e.g., one of the examples 74 to 81) or to any of the examples described herein, further comprising that the method comprises generating (240) the one or more profiles according to a script execution engine-agnostic format.
Another example (e.g., example 83) relates to a previously described example (e.g., one of the examples 74 to 82) or to any of the examples described herein, further comprising that the method comprises providing (270) the code as a file having a filename and providing (270) the one or more profiles as a file having a filename that is derived from the filename of the code.
An example (e.g., example 84) relates to a machine-readable storage medium including program code, when executed, to cause a machine to perform the method of one of the above methods, e.g., the method of one of the examples 59 to 73 or the method according to one of the examples 74 to 83.
An example (e.g., example 85) relates to a computer program having a program code for performing one of the above methods, e.g., the method of one of the examples 59 to 73 or the method according to one of the examples 74 to 83, when the computer program is executed on a computer, a processor, or a programmable hardware component.
An example (e.g., example 86) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for executing code written in a dynamic script language, the apparatus comprising interface circuitry and processing circuitry to:
obtain code written in the dynamic script language;
obtain one or more profiles for accelerating an execution of the code, the one or more profiles being bundled with the code; and
execute the code based on the one or more profiles.

2. The apparatus according to claim 1, wherein the one or more profiles comprise information on variable types of variables being used in the code.

3. The apparatus according to claim 2, wherein the processing circuitry is to execute the code with the variable types specified by the information on the variable types.

4. The apparatus according to claim 1, wherein the one or more profiles comprise metrics on one or more of a likelihood of one or more branches being taken, an approximate number of invocations of a function, a cache miss ratio, and a number of functions being executed, wherein the processing circuitry is to adjust the execution of the code based on the metrics.

5. The apparatus according to claim 1, wherein each profile is associated with a steady state of the execution of the code.

6. The apparatus according to claim 5, wherein dynamic aspects of the code are quasi-static during a steady state of the execution of the code, wherein the execution of the code transitions from a steady state to another steady state if a dynamic aspect of the code changes during execution of the code.

7. The apparatus according to claim 6, wherein the execution of the code transitions from a steady state to another steady state if at least one of a type of a variable, a metric on a likelihood of one or more branches being taken, a metric on an approximate number of invocations of a function, a metric on a cache miss ratio and a metric on a number of functions being executed changes during execution of the code.

8. The apparatus according to claim 1, wherein the processing circuitry is to obtain a plurality of profiles that are bundled with the code, with each profile being associated with a steady state of an execution of the code.

9. The apparatus according to claim 8, wherein the processing circuitry is to obtain information on one or more transitions between the steady states of the execution of the code that is bundled with the code, and to select a profile of the plurality of profiles based on the information on the one or more transitions between the steady states of the execution.

10. The apparatus according to claim 1, wherein the one or more profiles are defined according to a script execution engine-agnostic format.

11. The apparatus according to claim 1, wherein the processing circuitry is to request the code from a server as a file having a filename, and to request the one or more profiles from the server as a file having a filename that is derived from the filename of the code.

12. The apparatus according to claim 1, wherein the processing circuitry is to perform profiling during execution of the code to determine one or more further profiles, to merge the one or more profiles with the one or more further profiles, and to execute the codes based on the merged profiles.

13. An apparatus (20) for providing code of a dynamic scripting language, the apparatus comprising interface circuitry and processing circuitry to:
obtain the code written in the dynamic scripting language;
generate one or more profiles for accelerating an execution of the code;
bundle the code with the one or more profiles; and
provide the code bundled with the one or more profiles.

14. The apparatus according to claim 13, wherein the processing circuitry is to generate the one or more profiles by executing the code.

15. The apparatus according to claim 13, wherein the one or more profiles comprise profiling data with respect to dynamic aspects of the code.

16. The apparatus according to claim 13, wherein the processing circuitry is to determine variable types of variables being used, and to include information on the variable types of the variables being used in the code in the one or more profiles.

17. The apparatus according to claim 13, wherein the processing circuitry is to determine metrics on one or more of a likelihood of one or more branches being taken, an approximate number of invocations of a function, a cache miss ratio, and a number of functions being executed, and to include the metrics in the one or more profiles.

18. The apparatus according to claim 13, wherein the processing circuitry is to determine one or more steady states during the execution of the code, and to generate the one or more profiles based on the one or more steady states, so that each profile is associated with a steady state of the execution of the code.

19-22. (canceled)

23. A method for executing code written in a dynamic script language,
the method comprising:
obtaining code written in the dynamic script language;
obtaining one or more profiles for accelerating an execution of the code, the one or more profiles being bundled with the code; and
executing the code based on the one or more profiles.

24. (canceled)

25. A machine-readable storage medium including program code,
when executed, to cause a machine to perform the method of claim 23.
